(19) United States
(12) Patent Application Publication
(10) Pub. No.: US 2008/0169743 A1
(43) Pub. Date: Jul. 17, 2008

(54) Field emission electron gun and method of operating the same

(75) Inventors: Tadashi Fujieda, Mito (JP); Kishio Hidaka, Hitachiota (JP); Mitsuo Hayashibara, Hitachinaka (JP); Shun-ichi Watanabe, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/882,498

(22) Filed: Aug. 2, 2007

(30) Foreign Application Priority Data
Aug. 11, 2006 (JP) 2006-219139

(51) Int. Cl. H01J 61/52; H01J 1/02

(52) U.S. Cl. 313/37

(57) ABSTRACT

The present invention provides a field emission electron gun and its operating method. The field emission electron gun includes: an electron source including a fibrous carbon substance and a conductive base material for supporting the substance; a drawer device for causing electrons to be emitted by field emission; an accelerator for accelerating the electrons; and a means for heating the electron source. In the electron gun, the electron source is heated and held at the heating temperature before field emission, and thereafter the lowest heating temperature causing a range of fluctuation in the field emission current to fall within a predetermined value is adjusted when needed. By employing the electron gun and its operating method of the present invention, provided are various electron beam applied apparatuses each capable of continuously operating for a long time while being low in noise and high in resolution.

### BACKGROUND OF THE INVENTION

1. Field of the Invention

The present invention relates to a field emission electron gun and a method of operating the same.

2. Description of the Prior Art

Japanese Patent Application Laid-open Publication No. 2005-243389 (hereinafter referred to as “Patent Document 1”) has disclosed a field emission electron source for emitting electrons from an extremity portion of a carbon nanotube (CNT) connected to a cathode and an anode by applying an electric field to the cathode and the anode. Patent Document 1 has disclosed that an admolecular layer (contamination) is removed by heating at a flashing temperature of 100° C. to 1300° C. for 0.1 to 1.0 hour. This removal of an admolecular layer by heating is termed as a “flashing” process.

In addition, Patent Document 1 describes a thermal field emission electron source which performs field emission while being heated at a temperature of 0° C. to 1000° C., and which requires no flashing process to be carried out.

### SUMMARY OF THE INVENTION

A chief cause of fluctuation in a field emission current is a localized change in the work function which takes place due to a repeated series of a residual gas's adsorption (contamination) to, and desorption from, a field emission site in the extremity of a carbon nanotube. Specifically, when a residual gas which has a lower work function than the carbon nanotube adsorbs to the field emission site, this adsorption facilitates the field emission from the field emission site to which the gas has adsorbed, and thereby the field emission current increases locally. When the adsorbed gas desorbs from the field emission site later, the field emission current returns to the original level.

Even when the adsorbed gas is removed by flashing of the field emission electron source, the gas adsorbs to the field emission site during the field emission. This brings about a problem that the field emission current fluctuates again.

Furthermore, suppose a case where a carbon nanotube electron source is caused to perform field emission by introducing the carbon nanotube electron source in the vacuum after exposed to the atmosphere. In this case, it is impossible to completely remove the adsorbed gas only by heating the carbon nanotube electron source at a temperature of approximately 600K, and it is also impossible to obtain a stable field emission current without heating the carbon nanotube electron source at a temperature of not lower than 1000K once. Moreover, when the heating temperature is raised unnecessarily, the energy distribution of the field emission electrons spreads, although the field emission current is stabilized. This widely-spread energy distribution presents a cause of deteriorating the resolution of an electron microscope in a case where the carbon nanotube electron source is installed in the electron microscope.

An object of the present invention is to provide a field emission electron gun and a method of operating the same which make it possible to constantly obtain a stable field emission current for a long period of time, and to minimize the energy distribution of field emission electrons, which would be widely spread due to heating.

An aspect of the present invention for the purpose of achieving the foregoing object is a field emission electron gun including: an electron source having a conductive base material to which at least a carbon nanotube is fixed; a drawer device for causing the electron source to emit electrons by field emission; and an accelerator for accelerating the electrons emitted from the electron source. The field emission electron gun also includes a heater for heating the carbon nanotube, and the heater includes a switching device for switching between a flashing temperature and a field emission temperature. Moreover, the field emission electron gun is characterized in that the switching device includes a field-emission-temperature controller for determining the field emission temperature according to a value representing a field emission current. The electron source is heated and kept at the heating temperature before field emission, and the heating temperature is thereafter lowered. Thereby, the electron source is caused to perform the field emission while kept at a certain temperature. Furthermore, the field emission electron gun is provided with a means for detecting and monitoring the field emission current, and the temperature for heating the electron sources is thus controlled when needed in order that the field emission current can fluctuate within a prescribed range. In sum, the present invention is to heat and keep the carbon nanotube at the heating temperature, and to thereafter control the heating temperature while monitoring the current fluctuation.

It should be noted that Saito Yahachi (2002) Surface Science (hyomen kagaku), vol. 23, no. 38 has disclosed an example of a method of stabilizing a field emission current from a field emission electron source constituted of a carbon nanotube (hereinafter referred to as a “CNT electron source”). According to the above document, a field emission current is stabilized when a CNT electron source is caused to perform field emission at room temperature after being heated at 1300 K for one minute. In addition, Niels de Jonge (2005). Phys. Rev. Lett. vo. 94, 186807 has disclosed that a field emission current is stabilized when a CNT electron source is caused to perform field emission while kept at a temperature of not lower than 600K.

The present invention makes it possible to provide an electron gun capable of obtaining a stable field emission current constantly for a long period of time, and to control an energy distribution of the field emission electrons so as not to spread widely due to heating.

In addition, by applying an electron gun according to the present invention to electron-beam-applied apparatuses, for example, a scanning electron microscope (SEM) and an electron beam lithography, it is possible to provide the apparatuses which have a low noise level and a high resolution even while operated continuously for a long period of time.

### BEST MODE FOR CARRYING OUT THE INVENTION

The present invention is carried out as a field emission electron gun including: an electron source configured of a single fibrous carbon substance and a conductive base material supporting the fibrous carbon substance; a drawer device for causing electrons to be emitted by field emission; an accelerator for accelerating the electrons; and a means for heating the electron source. The field emission electron gun is characterized in that the electron source is heated and kept at the heating temperature before the field emission, thereafter the heating temperature is lowered. The field emission is then performed while the electron source is kept at a certain temperature.

The fibrous carbon substance is a fibrous substance essentially containing carbon, for example, a carbon fiber produced by vapor phase growth. A carbon nanotube can be cited as such a fibrous substance. A carbon nanotube with boron, nitrogen, a metal and the like mixed therein may be used.

The indirect heating of a carbon nanotube by electrifying a V-shaped filament to which a base material for the carbon nanotube is connected can be cited as a method of heating the electron source. A heater heats the carbon nanotube up to a flashing temperature once, and thereafter lowers the temperature of the carbon nanotube to the field emission temperature at which the carbon nanotube is kept. In this event, while the temperature of the carbon nanotube is being lowered, the field emission current is monitored. When the current fluctuates over a range of a predetermined value, the temperature is stopped from further lowering. Subsequently, the temperature of the carbon nanotube is raised up to a temperature at which a value representing the current fluctuates within the predetermined value, and then, the field emission starts to be performed.

It is desirable that an extremity of the carbon nanotube be not opened, and be closed with a cap including a five-membered ring.

Another characteristic of the present invention is that the electron gun of the invention is used for various electron-beam-applied apparatuses by use of the above-mentioned method of operating the electron gun.

### BRIEF DESCRIPTION OF THE DRAWINGS

FIG. 1 shows a configuration of an electron gun according to a first embodiment.

FIGS. 2A and 2B show SEM pictures of the extremity portion of a field emission electron source according to the first embodiment.

FIG. 3 shows a method of operating the electron gun according to the embodiment of the invention.

FIG. 4 shows an influence of a heating temperature on stability of a field emission current in the field emission electron source according to the present invention.

FIG. 5 shows an influence of the heating temperature on a current dependency of a half-value width of the energy (ΔE) of field emission electrons in the field emission electron source according to the present invention.

FIGS. 6A and 6B show other configurations of the electron gun according to a second embodiment. FIG. 6A shows a diagram of a configuration of the electron gun which detects a field emission current by use of an extracting electrode. FIG. 6B shows a diagram of a configuration of the electron gun which detects a field emission current by use of a stop provided under an accelerating electrode.

FIG. 7 shows another method of operating the electron gun according to the second embodiment.

FIG. 8 shows a diagram of an overall configuration of a scanning electron microscope (SEM) using the electron gun according to a third embodiment.

FIG. 9 shows a diagram of an overall configuration of an electron beam lithography using the field emission electron gun according to the present invention.

### DESCRIPTION OF THE PREFERRED EMBODIMENT

Detailed descriptions will be provided for embodiments of the present invention by seeing the drawings.

### Embodiment 1

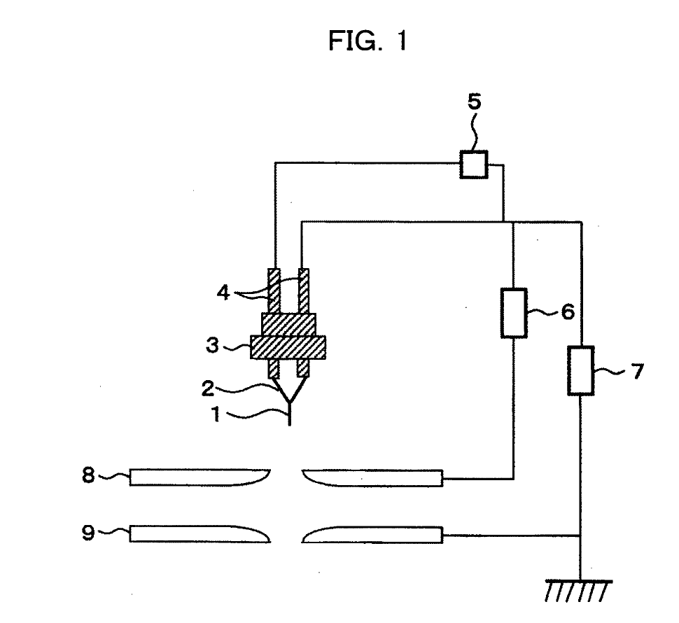

FIG. 1 shows a configuration of an electron gun according to a first embodiment. The electron source is configured of at least a carbon nanotube and a conductive base material supporting the carbon nanotube. The field emission electron gun includes: the electron source; an extracting electrode for causing electrons to be emitted; an accelerating electrode for accelerating the electrons; a drawer power supply for applying a voltage to the extracting electrode; an accelerating power supply for applying a voltage to the accelerating electrode; and a heating power supply for heating the electron source.

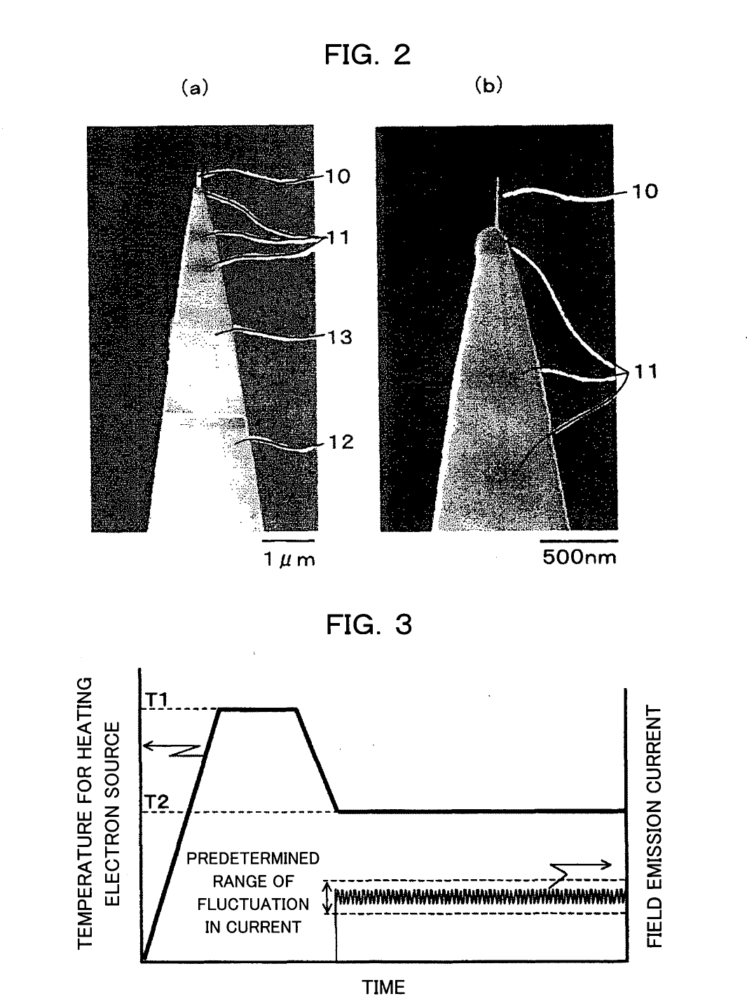

FIGS. 2A and 2B are SEM pictures of the extremity portion of the electron source according to this embodiment. The field emission electron source is configured of a single carbon nanotube, a conductive base material, a isolated supporting base for supporting the base material, and an electrode. A section where the carbon nanotube and the conductive base material are jointed to each other is reinforced with a conductive covering layer.

With regard to the shape of the carbon nanotube, it is desirable to have 10 nm to 200 nm in diameter in view of a field emission characteristic, electrical resistance and durability. In addition, it is desirable that the carbon nanotube be not more than 20 μm in length in view of electric resistance control of the carbon nanotube and vibration control of the carbon nanotube during field emission. Any other substance may be applicable as the field emission electron source according to this embodiment as long as the substance is a fibrous substance which takes on the same shape as the carbon nanotube, and which essentially contains carbon.

No specific restriction is imposed on the material for the conductive base material. It is desirable, however, that the material be a noble metal (specifically, gold, silver and an equivalent), crystalline carbon and a refractory metal (specifically, tungsten, tantalum, niobium, molybdenum and the like) in view of a heat resisting property, oxidation resistance and mechanical strength.

In addition, by an FIM process or the like, a flat surface is formed in the extremity portion of the conductive base metal whose extremity is sharpened by chemical etching or the like, for the purpose of controlling an angle between the center axis of the conductive base material and the carbon nanotube. Judging from a radiation angle at which an electron beam is emitted from the carbon nanotube, it should be noted that it is difficult to control the optical axis of the electron beam without having the angle between the center axis of the conductive base material and the carbon nanotube confined within a range of ±5 degrees.

Subsequently, descriptions will be provided of a method of forming the conductive covering layer in the section where the carbon nanotube and the conductive base material are jointed to each other. In a chamber into which a gas containing a conductive element is introduced, a beam of electrons is emitted on at least a part of an area where the carbon nanotube and the conductive base material are in contact with each other. This makes it possible to form the conductive covering layer with a sufficient thickness in a short period of time. By using this method, it is possible to locally cover and reinforce the section where the carbon nanotube and the conductive base material are jointed to each other with the conductive covering layer without adhering the conductive covering element to the carbon nanotube jutting out from the conductive base material.

A gas which is dissolved only by a high-energy heavy-ion beam, such as a gallium ion beam, which is usually used for an FIB process and the like, can not be used as the gas containing the conductive element. This is because, when the high-energy heavy-ion beam is emitted on the carbon nanotube, the carbon nanotube itself is instantaneously damaged so that the carbon nanotube is fractured or an irradiation defect takes place. With this taken into consideration, it is desirable that an electron beam with an energy of not larger than 100 KeV which does not damage the carbon nanotube, be employed as a particle beam used for dissolving the gas. In addition, it is desirable that an organic metal gas essentially containing a metal, such as carbon, platinum, gold, tungsten or the like, and a fluoride gas be used as the gas containing the conductive element, the organic metal gas and the fluoride gas dissolved by use of an electron beam with an energy of not larger than 100 KeV and concurrently vaporized at a temperature of not higher than 100° C. The irradiation of an electron beam on these gases makes it possible to locally form the conductive covering layer only in the section where the carbon nanotube and the conductive base material are jointed to each other.

FIG. 3 shows how the electron gun according to the present embodiment operates. First of all, the electron source according to the present invention is installed in an apparatus. Subsequently, the electron source is once heated with conditions that the heating temperature is T1 (873K to 1123K) and the heating time length is one minute to 60 minutes, before caused to perform a field emission. Thereafter, the electron source is caused to emit electrons by field emission while the heating temperature is kept at a temperature T2 (<T1). This makes it possible to cause a coefficient of fluctuation of the field emission current to fall within a predetermined range.

FIG. 4 shows a result of examining the current stability which was observed in a case where the electron source according to the present invention was caused to perform a field emission while heated and kept at each of the temperatures, at room temperature, 573K and 923K, after the electron source was once heated with conditions that the heating temperature was 973K (700° C.) and the heating time length was 20 minutes. In a case where the electron source was not heated or kept at the heating temperature, a current fluctuation in the shape of steps or pulses was observed. By heating and keeping the electron source at the temperature of not lower than 573K (300° C.), however, the current was stabilized. In other words, a temperature at which the gas did not adsorb to the extremity of the carbon nanotube was not lower than 573K. In addition, a temperature needed for removing the gas once adsorbed to the extremity of the carbon nanotube was not lower than 973K.

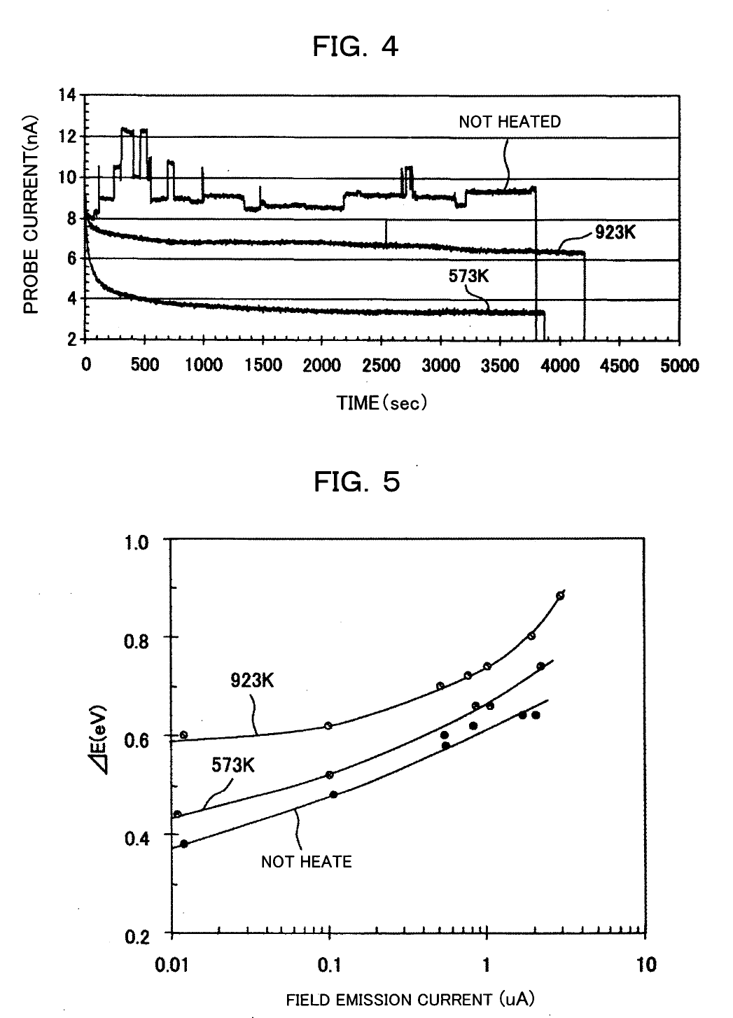

FIG. 5 shows a result of examining the current dependency of a half-value width of the energy (ΔE) of field emission electrons which was observed in a case where the electron source according to the present invention was caused to perform a field emission while heated and kept at each of the temperatures, at room temperature, 573K and 923K, after the electron source was once heated with conditions that the heating temperature was 973K and the heating time length was 20 minutes. ΔE increased as the heating temperature increased in comparison with a case where the electron source was not heated or kept at the heating temperature. From this, it was learned that, for the purpose of holding the increase in ΔE to a minimum, the heating temperature needs to be set as low as possible within a temperature range in which the current is stabilized.

It should be noted that the extremity of the fibrous carbon substance constituting the electron source according to the first embodiment has a closed structure. In a case of a carbon nanotube having an opened structure, in which the extremity of a fibrous carbon substance is opened and shaped like a tube, the current was not stabilized even while the carbon nanotube was heated.

### Embodiment 2

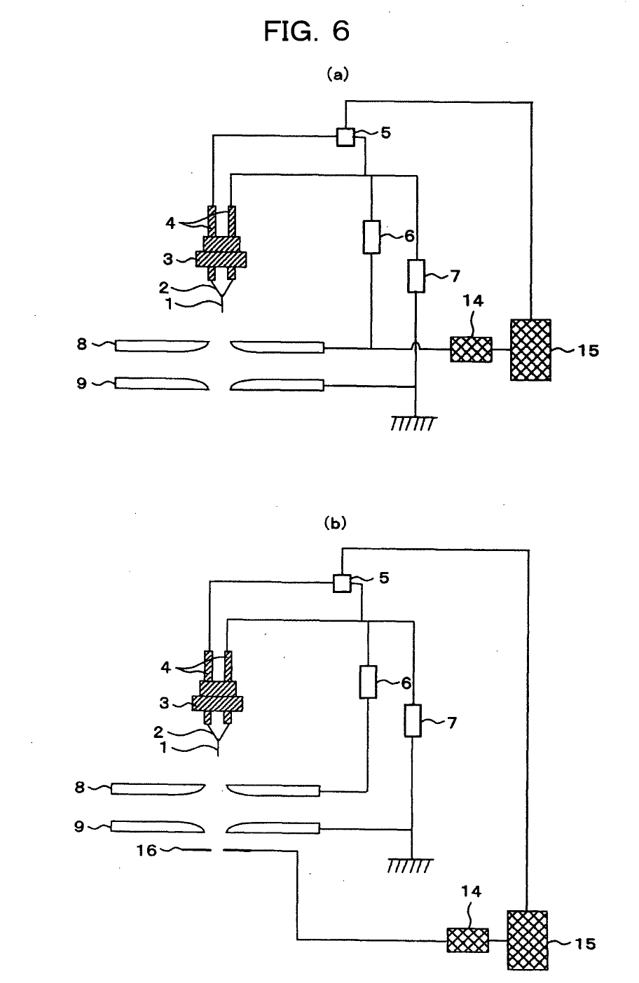

FIGS. 6A and 6B respectively show examples of the electron gun according to the present invention. For the purpose of lowering the heating temperature as described above, this electron gun has a configuration in which a means for detecting the field emission current and a means for monitoring the field emission current are added to the electron gun shown in FIG. 1. It should be noted that the field emission current is capable of being detected by the extracting electrode (as shown in FIG. 6A) or the stop provided under the accelerating electrode (as shown in FIG. 6B).

The current fluctuation which takes place during field emission is beforehand examined, and an appropriate range of the current fluctuation is set. Thereby, the field emission current monitoring device constantly monitors whether or not the field emission current falls within a predetermined range of the current fluctuation. In addition, the heater is controlled in accordance with a result of the monitoring.

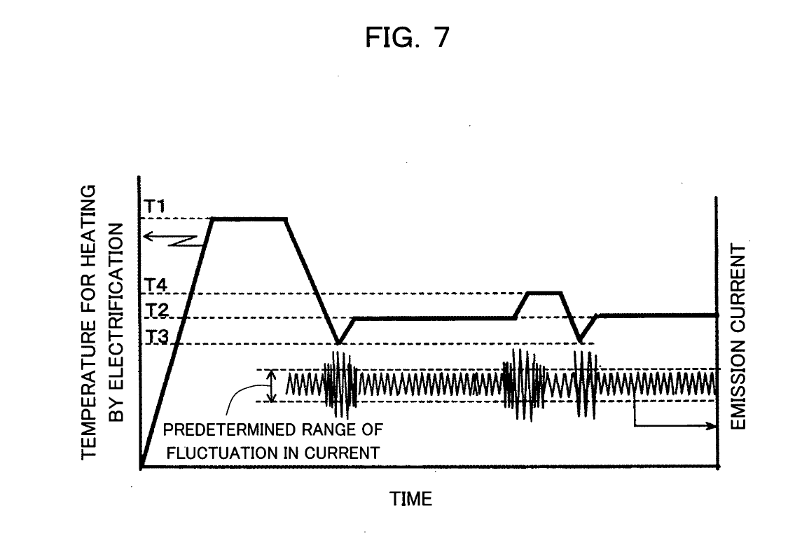

FIG. 7 shows how the electron gun according to the second embodiment operates. Before caused to perform a field emission, the electron source is once heated with conditions that the heating temperature is T1 (873K to 1123K) and the heating time length is one minute to 60 minutes. Thereafter, while the electron gun is being caused to perform the field emission, the heating temperature is lowered to temperature (T3) which causes the field emission current to go beyond the predetermined range of the current fluctuation by detecting and monitoring the field emission current. In the process of lowering the heating temperature, the lowest temperature (T2) which causes the field emission current to falls within the predetermined range of the current fluctuation is determined. Subsequently, the temperature of the electron source is raised to temperature T2 again, and is kept at temperature T2.

Thereafter, in a case where the field emission current goes beyond the predetermined range of the current fluctuation, the heating temperature is raised to temperature (T4) which causes the field emission current to fall within the predetermined range of the current fluctuation. Afterward, the heating temperature is lowered to temperature (T3) which causes the field emission current to go beyond the predetermined range of the current fluctuation. In the process of lowering the heating temperature, the lowest temperature (T2) which causes the field emission current to fall within the predetermined range of the current fluctuation is determined. Subsequently, the temperature of the electron source is raised to temperature T2 again, and is kept at temperature T2.

This operation method is capable of being controlled manually. However, an automated operation using the monitoring device makes it possible to continuously obtain a stable field emission current for a long period of time, and to minimize the spread of ΔE which takes place due to heating. Moreover, the holding of the heating temperature to a minimum is advantageous in a view of the heat resistance of the section where the fibrous carbon substance and the conductive base material are jointed to each other in the electron source according to this embodiment.

### Embodiment 3

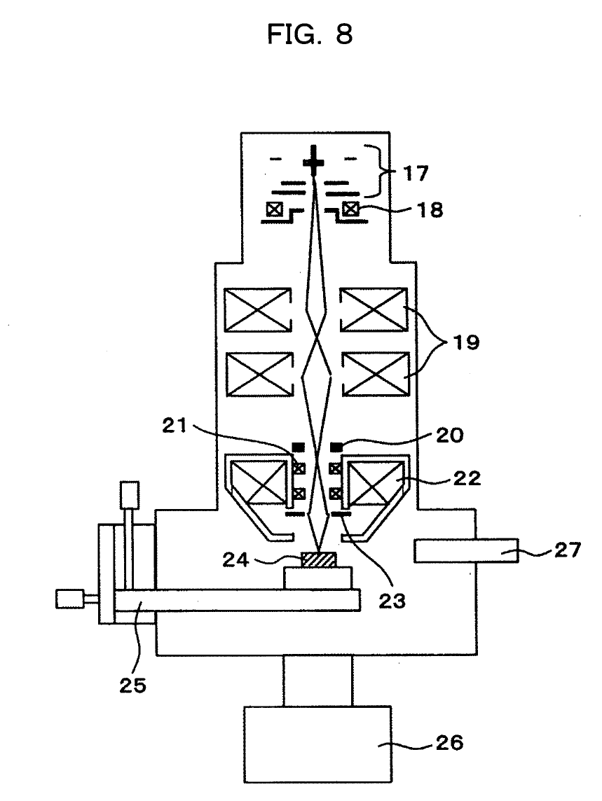

FIG. 8 is a diagram showing an example of an overall configuration of a scanning electron microscope (SEM) to which the electron gun according to the present invention is applied.

In the scanning electron microscope, an alignment coil, a condenser lens, an astigmatic correction coil, a deflecting/scanning coil, an object lens and an object stop are arranged sequentially along an electron beam of emitted from the electron gun. A sample is placed on a sample stage, and the electron beam is emitted on the sample. A secondary electron detector is provided in a sidewall portion of a sample chamber. In addition, the sample chamber is designed to be held in high vacuum by a discharge system. With this configuration, the electron beam emitted from the electron gun is accelerated by an anode, and is condensed by the electron lens. Thereby, the resultant electron beam is emitted on a minute area on the sample. This irradiated area is scanned over two-dimensionally. Thereby, secondary electrons, reflection electrons and the like which are emitted from the sample are detected by a secondary electron detector. According to the difference in the amount of detected signals, an magnified image is formed.

The application of the electron gun and the operating method according to the present invention to a scanning electron microscope makes it possible for the scanning electron microscope to be operated continuously for a long period of time. In addition, data to be obtained has a low noise level, and ΔE is small. Hence, a scanning electron microscope with a high resolution can be made. For this reason, the electron gun and the operating method according to the present invention can also be applied to a measurement SEM used for observing micro-processed patterns and measuring the dimensions in a semiconductor process which requires the SEM to be operated continuously for a long period of time. A basic configuration of an electron-optical system of the measurement SEM is common with that of the regular SEM (as shown in FIG. 8). Although the basic configuration of the measurement SEM from the electron source to the sample stage is common with that of the regular SEM, the measurement SEM is different from the regular SEM in the configuration of the sample stage, and in that a length measuring system through image processing is installed in the measurement SEM. The measurement SEM includes: a structure enabling the sample stage to be driven fast; a system for controlling the stage driving structure; and a system for image processing.

A conventional type of field emission electron gun is configured of a single crystal tungsten electron source, and needs heat flashing in intervals of approximately 10 hours. No emission can be carried out during the flashing process. In addition, the emission current is not stabilized in one hour after the flashing process. These obstruct a stable observation. The semiconductor process line needs to be in operation continuously for 24 hours a day, and is accordingly not allowed to be out-of-operation each time a flashing process is carried out. This makes it impossible to install the conventional type of field emission electron gun in the scanning electron microscope.

It should be noted that the configuration of the scanning electron microscope in which the field emission electron gun is installed includes, but is not limited to, the configuration shown in FIG. 8. Any conventionally known configuration can be adopted as long as the configuration causes the field emission electron gun to exhibit its characteristics fully.

### Embodiment 4

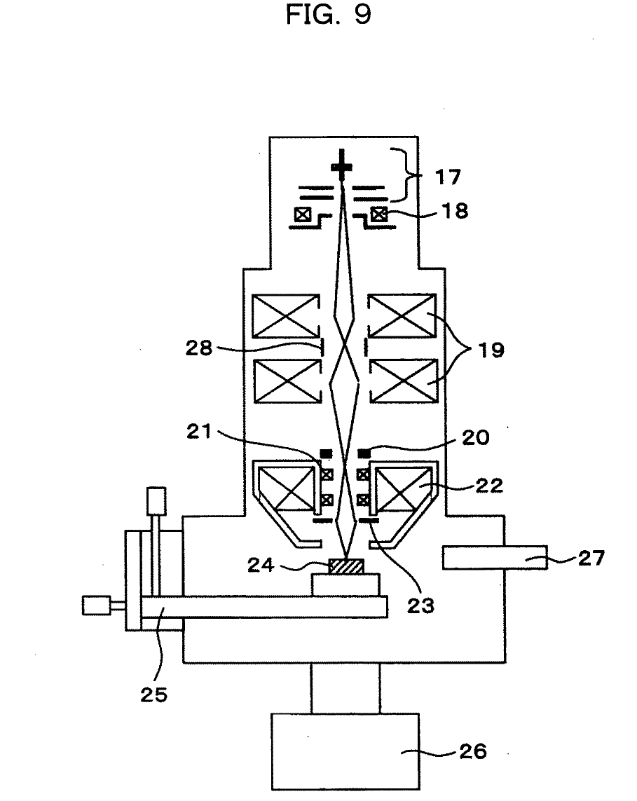

FIG. 9 shows an example of an overall configuration of an electron beam lithography in which the field emission electron gun according to the present invention is installed. The basic configuration of the electron-optical system is almost the same as that of the foregoing scanning electron microscope. An electron beam obtained from the electron gun by field emission is condensed by the condenser lens, and the resultant electron beam is focused on the sample by the object lens. Thereby, a beam spot in a nanometer order size is obtained. It is desirable that the center of the blanking electrode for controlling whether or not the electron beam should be emitted on the sample agree with a crossover point formed by the condenser lens.

The electron beam rendering is carried out by emitting the electron beam while the electron beam is being turned on and off by the blanking electrode, and while the electron beam is deflected and scans over the sample by the deflection/scanning coil. The electron beam lithography forms various circuit patterns by emitting the electron beam on a sample substrate to which a resist sensitive to the electron beam is applied. As the various circuit patterns are constructed in an increasingly fine scale, a demand for an electron gun whose probe is extra fine in diameter has become stronger. Electron sources of a thermal-electron-emission type which is made of a tungsten filament or LaB₆ have been heretofore in use for electron guns. These electron guns are advantageous in that a larger amount of beam current can be gained from the electron guns. On the other hand, these electron guns have an astigmatism which takes place due to the larger diameters of their respective emitter extremities in an absolute term. This makes it impossible for these electron guns to render lines which are 20 nm or narrower in width. For this reason, field emission electron guns of a type which is configured of a single crystal tungsten electron source are increasingly in use recently. Nevertheless, field emission electron guns of this type are incapable of performing a secure rendering operation because the beam current is small in amount and is unstable.

Use of the electron source according to the present invention makes it possible for the operation to be performed continuously. Moreover, the smallness of ΔE makes it possible to obtain a fine rendering operation. The application of the electron gun and the operating method according to the present invention makes it possible to solve the foregoing problems.

What is claimed is:

1. A field emission electron gun including: an electron source including a conductive base material to which at least a fibrous carbon substance is fixed; a drawer device for causing the electron source to emit electrons by field emission; and an accelerator for accelerating the electrons emitted from the electron source, the field emission electron gun comprising:
a heating means for heating the fibrous carbon substance; and
a controller for controlling the heating means,
wherein the controller heats and keeps the electron source at a predetermined heating and holding temperature before field emission, and lowers the temperature of the electron source to a field emission temperature lower than the heating and holding temperature during the field emission.

2. The field emission electron gun according to claim 1, wherein the controller includes a function of adjusting the field emission temperature according to a range of fluctuation in a field emission current.

3. The field emission electron gun according to claim 1, comprising a monitoring device for detecting the field emission current during the field emission,
wherein the controller includes a function of adjusting the field emission temperature according to information from the monitoring device.

4. The field emission electron gun according to claim 2, wherein the controller includes a function of heating the fibrous carbon substance to the lowest heating temperature which causes a range of fluctuation in the field emission current to be not larger than a predetermined value in a case where the range of the fluctuation goes beyond the predetermined value.

5. The field emission electron gun according to claim 3, wherein the controller includes a function of heating the fibrous carbon substance to the lowest heating temperature which causes a range of fluctuation in the field emission current to be not larger than a predetermined value in a case where the range of the fluctuation goes beyond the predetermined value.

6. A method of operating a field emission electron gun including the steps of:
heating and thus purifying at least a fibrous carbon substance in an electron source using the fibrous carbon substrate;
lowering the temperature of the heated fibrous carbon substance;
causing electrons to be emitted, by field emission, from the fibrous carbon substance whose temperature is lowered; and
accelerating the electrons emitted by field emission,
wherein in the step of causing electrons to be emitted by field emission, the fibrous carbon substance is heated to a predetermined temperature lower than a temperature at which the fibrous carbon substance is purified.

7. A scanning electron microscope including: an electron gun; a sample stage provided in a position to be irradiated with an electron beam emitted from the electron gun; and a detector for detecting electrons scanning over the sample, wherein the electron gun comprises:
an electron source including a conductive base material to which a fibrous carbon substance is fixed;
a drawer device for causing the electron source to emit electrons by field emission;
an accelerator for accelerating the electrons emitted from the electron source;
a heating means for heating the fibrous carbon substance; and
a controller for controlling the heating means,
wherein the controller heats and keeps the electron source at a predetermined heating and holding temperature before field emission, and lowers the temperature of the electron source to a field emission temperature lower than the heating and holding temperature during the field emission.

8. The scanning electron microscope according to claim 7, further comprising:
a driver for driving the sample stage;
a driver controlling system for controlling the driver; and
a length measuring system for processing an image obtained from the electron microscope.

9. An electron beam lithography including: an electron gun for emitting an electron beam onto a sample substrate; a deflection/scanning coil for deflecting the electron beam and for causing the electron beam to scan; and a blanking electrode for turning on and off the electron beam, wherein the electron gun comprises:
an electron source including a conductive base material to which a fibrous carbon substance is fixed;
a drawer device for causing the electron source to emit electrons by field emission;
an accelerator for accelerating the electrons emitted from the electron source;
a heating means for heating the fibrous carbon substance; and
a controller for controlling the heating means,
wherein the controller heats and keeps the electron source at a predetermined heating and holding temperature before field emission, and lowers the temperature of the electron source to a field emission temperature lower than the heating and holding temperature during the field emission.
